(19) United States
(12) Patent Application Publication
(10) Pub. No.: US 2002/0107731 A1
(43) Pub. Date: Aug. 8, 2002

(54) Purchase-based reward system and method

(76) Inventor: Patrick Chee-Wai Teng, Singapore (SG)

Correspondence Address: BRUCE LONDA, NORRIS, MCLAUGHLIN & MARCUS, P.A., 220 EAST 42ND STREET, 30TH FLOOR, NEW YORK, NY, 10017, US

(21) Appl. No.: 09/778,328

(22) Filed: Feb. 7, 2001

(51) Int. Cl. G06F 17/60

(52) U.S. Cl. 705/14

(57) ABSTRACT

A system for administering a purchase-based reward system, having an administering entity, memberships issued by the entity to members, merchants participating in the system, and a monetary trustee account. When a member makes a purchase through a participating merchant, a monetary value based on the purchase is debited from the merchant and credited to the trustee account. The member making the purchase is credited with reward points based on the purchase, and the reward points are redeemable based on a corresponding value drawn from the trustee account.

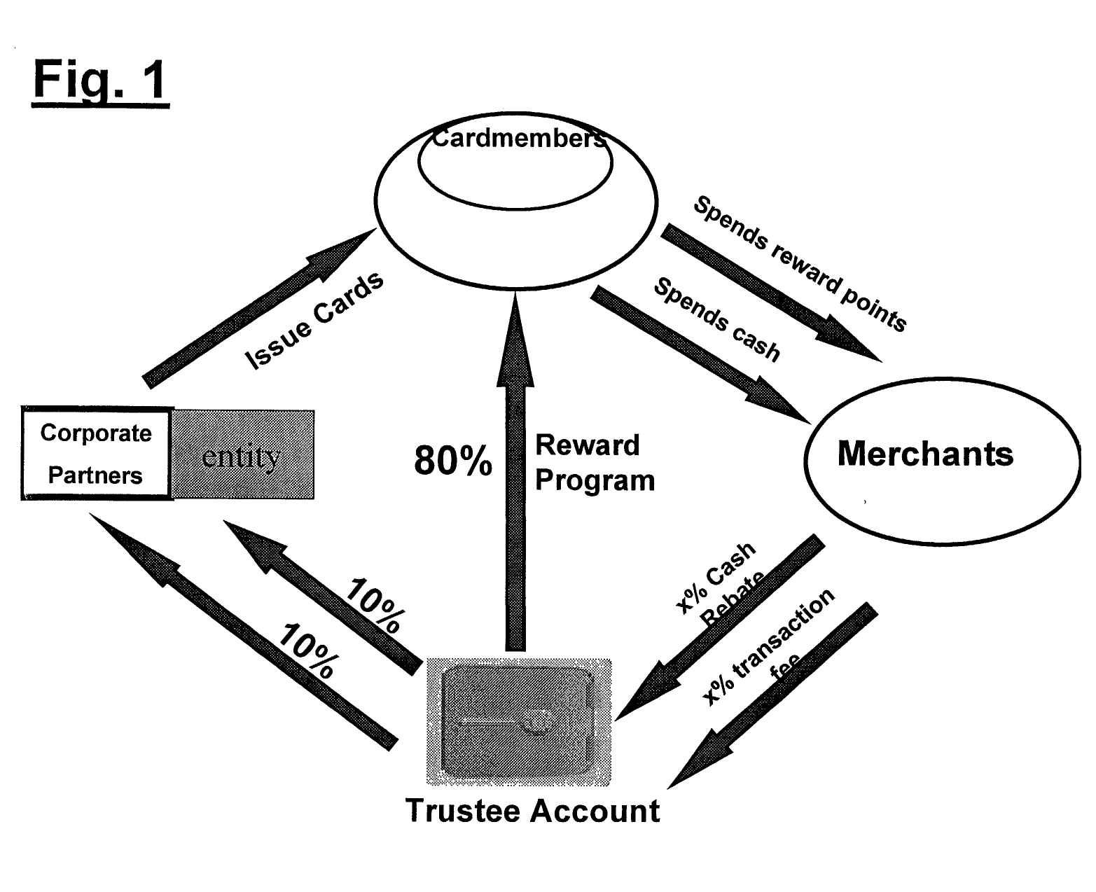

### FIELD OF THE INVENTION

This invention relates to a method and system for promoting consumer expenditure, and more particularly to a method and system for recycling and transforming consumer spending into a rewards program based on a virtual currency.

### BACKGROUND OF THE INVENTION

Methods and systems for promoting consumer spending are well known. Such methods and systems are generally designed to reward a credit card holder for exhibiting behavior preferred by a credit card issuer. Reward accrual programs promote usage of a credit card account by rewarding a card holder for account usage with either rebates or redeemable program points. In such programs, account usage is typically measured as a function of either total charge volume or total revolving credit. Generally, card holder performance is measured monthly, and rewards are distributed based on the monthly measurements.

A frequent flyer mile reward program is one example of a reward accrual program. Another example of a reward accrual program is the annual cash rebate reward offered by the issuer of the Discover® card. The issuer of the Discover card offers an annual cash rebate based upon a card holder's annual charge volume. The issuer analyzes card holders' annual charges and rewards card holders up to 1 percent cash back for qualifying transactions completed using the Discover card. Another example of a reward accrual program is the General Motors® MasterCard® (“GM Card®”) automobile rebate program offered through Household Bank™. Household Bank awards GM Card holders rebate dollars redeemable upon a purchase of a GM brand automobile. Like the Discover card program, GM Card holders accrue redeemable credits based on transactions completed using the GM Card.

Through programs such as the Discover and the GM Card reward accrual programs, card holders are rewarded for account usage based on predetermined objective criteria. These programs have several significant shortcomings. They fail to recognize the concept that different types of reward are required to provide an incentive for different types of card holders. In the above-described programs, the same type of rewards and the same level of rewards apply to an entire group of card holders. This one-size-fits-many approach fails to motivate those card holders who may be more interested in other types of reward offers.

In addition, the rewards are predefined for the entire population of participating card holders. A card holder who is not interested in the offered rewards will not be motivated to perform at a higher level. These programs are not customized to the preferences of the individual card holders. The rewards are limited to specific services and merchandise offered by the card entity.

Thus, it is desirable to provide a rewards program that allows consumers to choose where (which merchants) and how (what goods or services) to claim earned rewards. In addition, an ideal rewards program would recycle consumer spending and transform it into a powerful medium of exchange as flexible and as useful as cash.

### DETAILED DESCRIPTION

A method and system is disclosed whereby a significant percentage of consumer spending is recycled and transformed into a new form of virtual currency, having a real cash value. The system as a whole is managed by a principal entity. Together with selected corporate partners, an entity issues electronic cards to specific consumers (“card members”), who make purchases at participating merchants selected by the entity. With each purchase, the entity rewards the user with a specific amount of credit or points in the form of the virtual currency, in an amount determined by a formula which may be specific to each merchant, but which is preferably related to the amount of the purchase. Rather than discounting the merchandise, the cardmember pays the full amount. The merchant then makes a cash deposit (or more likely an electronic cash transfer) of a certain percentage of the purchase into the system's trustee account, which is managed by an independent and disinterested third party, having no relationship to the entity per se. In addition, in a preferred embodiment, with each purchase, the merchant pays a set fee (e.g. a percentage of the purchase amount) directly to the account of the entity as a transaction fee. However, this fee may be waived or left out of the system at the option of the entity. Set percentages of the accumulated funds in the trustee account are set aside for the benefit of one or several of the entity, the corporate partners, the merchants, and the cardmembers.

Every reward point (virtual currency) is backed by the funds of the trustee account, so that each reward point has an intrinsic cash value, convertible to a hard currency. However, it is contemplated that free conversion to hard currency by the cardmembers will only be possible once a minimum amount in the trustee account has been accumulated. Since the reward points have a real cash value, they can be freely accepted by fully participating merchants (i.e. those that offer reward points to cardmembers upon purchase), or those merchants who do not participate in offering rewards but nevertheless choose to accept reward points from cardmembers in place of hard currency. Once accepted by the merchant, the virtual currency points can be exchanged at the trustee account for hard currency. The clear difference between prior art reward systems and the present system is thus the ability to use reward points in a substantially unfettered manner. Rather than limiting the exchange of reward points to merchants chosen by the entity, the present system allows any merchant to decide to accept reward points in exchange for cash equivalent from the entity (through the trustee account). Thus, the reward points are ‘as good as cash’. However, the benefit to the entity and its participating corporate partners and merchants, is that the ‘cash’ is nonetheless ‘virtual’, being convertible only through the system itself. Accordingly, each purchase or ‘redemption’ using reward points can still be evaluated for marketing data purposes, even through non-member merchants.

A major benefit to the corporate partners and the participating merchants is the opportunity to receive detailed consumer profile information (data mining) about the cardmembers. For the corporate partners in particular, this may be a major consideration for participating in the system. By lending its notoriety to the promotion of the system, and by issuing cards to a selected group of consumers, the entity receives a valuable cardmember base and promotion of the system. In exchange, the corporate partner receives valuable marketing data. While the entity may receive a fee from the corporate partner for each card, it is also contemplated that the entity will allow the corporate partner to issue cards without a fee to the entity. This is possible since the benefit to the entity in terms of publicity and creation of a cardmember base has exceptional value. The result is that the corporate partner receives valuable data mining information, which is usually obtained only at considerable expense.

The entity tracks the spending habits of each cardmember electronically in connection with the use of the card. Information is also available to merchants and corporate partners to better understand their customers and provide an effective, efficient surveying tool for marketing purposes. The marketing information is also useful to the cardmembers, since merchants can then target specific offers to the cardmember based upon known preferences.

An important part of the system is a website provided by the entity, where all the components of the system may converge. At the website, cardmembers can obtain information and conduct transactions, thereby creating a new and powerful interface of virtual and real world commerce. The website is updated frequently, preferably in real-time or near real-time, and allows the cardmember to check his rewards account. It will also alert the cardmember to the most valuable rewards offered by merchants on a daily basis, as well as providing a location for general information about participating merchants.

The Components of the System

The components of the system and their relationship to each other are now more fully described, in conjunction with the attached figure.

In addition to the controlling entity, the first component of the system is the corporate partner (“CP”). Preferably, the CP is a large and well-known establishment, with a large, well-defined customer base. This may be a corporation, public service provider (utility, telecom), charity or non-profit group, etc. The CP acts with the entity to issue a joint card to the CP's customer base. The CP pays a small fee per card to the entity (or no fee, as described above in certain circumstances). The entity may also issue cards to random consumers.

The second component is the cardmember, to whom a card is issued. The cardmember is the ultimate customer of the corporate partner, the merchant base, and the entity.

The third component is the merchant participant. The merchant participates in the system rewards program by recognizing the use of the card in the following manner:

The cards, whether issued by corporate partners, merchants, or the entity itself, are preferably of the type having a magnetic data stripe. They can, but do not necessarily, act simultaneously as a regular credit, debit or bank card. If used as a stand-alone card, the card is presented to a merchant along with another purchase means, and swiped. The information is communicated electronically with the system, so that the proper reward points can be automatically credited to the cardmember's account, and so that the amount of the merchant's contribution to the system can be recorded. It is possible to initiate an automatic transfer from the merchant's bank account directly into the system, or the merchant may authorize payment specifically. To achieve both of the above objectives most easily, the card reader should be linked to the merchant's purchase system (e.g. linked to the cash register), so that details of the purchase information (i.e. goods or services) can be simultaneously transmitted to the system for data-mining purposes. It can thus be seen that a combination system card and credit card can be used to initiate all related transactions.

The merchant has a contract with the entity to rebate a specific percentage of every purchase amount spent by cardmembers into the trustee account. Thus the reward offered to the cardmember does not accrue directly or immediately to the cardmember as a discount to the total bill; but instead accrues to the individual rewards account as points and to the trustee account as cash. However, the funds in the trustee account are always owned by the entity. The cash value is only redeemable through a contractual relationship between the merchants and cardmembers on one hand, and the entity on the other.

The merchant may be allocated a certain number of merchant-rewards cards to be issued to the merchant's most important customers. In return, the merchant gives a refundable deposit to the entity, to be refunded when the merchant leaves the program.

The fourth component is the disinterested third party that will manage the trustee account. Preferably, the third party will be a world-class financial institution.

In a preferred embodiment, the allocation of funds within the system is as follows. It should be noted that the specific percentages are a preferred example, but that other varying percentages may be used within the system:

1. A full 80% of the funds circulating in the system may only be used to fund and operate the rewards portion of the program (“core funds”). Such benefits will include the redemption of reward points for hard currency when presented by a merchant which has agreed to accept the points in place of cash value.

a. Of the core funds, a maximum of 20% may be disbursed to the entity for the expenditure incurred in operating the system.

2. 10% of the total funds within the system will be paid to the entity as a commission or royalty.

3. 10% percent of the total funds received will be paid to the corporate partner (or merchant) card issuer as a commission. However, this commission can not used by the CP as general revenue; but can only be used by the CP to further operate, promote and market its participation in the rewards program. In addition, the commission may be used by the CP to cover the cost any fees paid by the CP to the entity.

The primary component of the system is the entity which issues the cards (possibly in conjunction with CP's and merchants) and handles all transactions between all components of the system. For all cards, regardless of source of issue, a common brand identity exists.

In order to maintain the system at a particular level, which is maintainable and useful in terms of data mining potential, the cardmember levels may be limited according to a general allocation formula. Thus, for each city, cards may be issued to only 30% of the population, while a set number of cards may be issued in another city having a particular income profile.

Different types of cards may be issued. For example, there can be three categories of cards, such as:

1. An exclusive card issued to the top 3% of income earners of each city in which the system operates.

2. The CP-entity joint card (co-branded, jointly issued card) issued to the elite and general membership base of the corporate partner's customer base.

3. The entity-merchant card issued to the top category of the merchant's customers.

The Process of the Rewards Program

The process of the present invention transforms consumer spending to achieve valuable rewards to the satisfaction of individual customers, i.e. the cardmembers. Points create real value to the customer by multiplying the value of what he or she spends within the rewards program.

Issuing the Rewards Card

The process begins with the issuing of the rewards card to members, free-of-charge. There is no qualifying income criteria (except in the case where the rewards card is also a credit card; in that case, the issuer may follow its usual credit criteria).

The card may be issued by the corporate partner jointly with the entity to the CP's ‘VIP’ and general customer base; it may be issued by the participating merchant jointly with the entity to the merchant's VIP customer base; or it may be issued by the entity itself to a select group of consumers, such as the top 3% of income earners of a geographical region.

The cardmember uses his rewards card at participating merchants and collects reward points.

When making the purchase, the merchant swipes the rewards card through the card reader. This will credit the cardmember with the offered number of reward points to the cardmember's reward points account. In a preferred embodiment, the merchant's card reader will be replaced with a point-of-sales computer terminal which will be able to capture the precise spending details of the cardmember at the merchant establishment.

The merchant rebates a percentage of the cardmember's purchase to the financial instrument.

Participating merchants are merchants who have contractually agreed to submit a payment to the trustee account relative to a percentage of purchases by cardmembers. The cardmembers pay in full to the merchants, without discount, earning instead the offered number of reward points.

The merchant pays a cash rebate to the trustee account. This cash rebate would typically be 10% to 20% of the total cardmember purchase. It may, however, be significantly lower, in the case where there is a high demand for the merchant's goods, as in a supermarket chain) or significantly higher (where the merchant is a restaurant with a low lunch or dinner demand, or a hotel or resort chain during low season). The merchant is also charged a small transaction fee payable to the entity.

The trustee account collects and recycles or transforms a significant percentage of total consumer (cardmember) spending.

The independent financial institution managing the trustee account will be a reputable or AAA-grade international bank. It will disburse the collected funds in strict accordance to a financial document voluntarily drawn up by the entity, and which document is made available to the public on the entity's website.

The rewards

The rewards are claimed by the cardmembers by redeeming the points accumulated in their account.

In the first instance, they will be able to use their points to pay for purchases at the participating merchants. The points will have a cash value, which may fluctuate with respect to a convertible hard currency. The convertible value of the reward points may depend on several factors, including the form of investment holdings of the trustee account, as well as predetermined formula which is built into the system.

Thus, reward points of the present invention may be used to pay, e.g. phone bills, petrol bills, insurance premiums, grocery bills; as well as for entertainment and dining, and purchase of goods and services in general. In other words, the reward points can be used in the same way as cash, thus providing a strong incentive for the cardmembers to continue to use the card in connection with purchases, so as to accumulate reward points.

As an added incentive for the cardmember, the entity may offer its cardmembers extremely discounted deals by negotiating with merchants and volume discounts. These offers are preferably purchased with reward points. The entity may choose to pass along all savings to the cardmembers choosing these deals, without adding a mark-up or commission on the purchase. This is possible because the entity will earn income from basic purchases alone, while the availability of special discounted deals will only provide increased incentive for the cardmember to accummulate still further reward points based on basic purchases.

Convertibility

When the trustee account reaches a certain critical size, points will be convertible for cash. This means that the cardmember can elect to use his or her points to pay for any purchase whatsoever, simply instructing the customer service officer on the website to debit his or her account and send a cheque, or electronic transfer, in the hard currency equivalent to the payee of his or her choice.

The Entity Website

The meeting point of all components of the rewards program is the entity's website. It is the focal point of information and all e-commerce activities relating to its cardmembers, merchants and corporate partners.

The individual cardmember will access the website to check his or her reward point account balance, accessible with the logging of his or her personal security password.

The merchants will post special rewards offered for their goods and services. The website allows for the merchants to post intra-day promotions and special offers that can be customized to the micro-management of their supply-and-demand situation. For example, what looks like an anticipated thin crowd for dinner, coupled with the unexpected onset of rain, will mean lack of business that evening, unless the restaurant merchant offers an enticing 50% rebate for dinner, with correspondingly more reward points than the normally offered 10% rebate. Cardmembers wondering where they might have dinner that evening can search the website for which merchant is giving the best rewards deal that particular evening, and such information can be obtained on personal wireless communication devices, in addition to the entity's website.

Other industries that will find the ability to post intra-day promotions helpful are hotels, where the day is ending without rooms filled, translating into revenues forever lost. With the entity's website, however, hotels can post special deals by a certain time.

Both the merchant and the corporate partner may also access the website to receive the spending profiles of their customers, in order to feed an increasingly sophisticated customer relations management database. Such a profile and vital data will be given out by the entity in accordance with agreed upon parameters of information consistent with the protection of individual privacy.

The system website itself can be a revenue generator, separate and apart from the operation of the system, based on e.g. site advertising revenue. While most websites compete with all other sites to attract ‘hits’ , the entity's website will have a built-in viewership. The cardmembers will have to visit the website to manage their rewards account, and to learn about participating merchants and special offers. Thus, compulsion rather than curiosity, drives traffic to the site. The most important point, however, is that even if cardmembers were to never visit the website, the success of the system is unaffected because it is not dependent on the number of hits on the website.

Data Mining and Customer Relationship Management

A final plank of the business model calls for the employment of sophisticated data mining capabilities. Understanding the cardmembers' needs through data-mining is critical to adjust and manage the merchants platform and rewards offered that continually satisfy the members and encourage them to accumulate points. Understanding the members through data mining will enable the entity to select merchants and understand the spending patterns of the members so that the rewards they receive are always of great value to them, and never irrelevant.

Understanding the cardmembers also enables a capture of an increasingly larger share of their spending—personal, family, and discretionary—that will drive the revenues generated by cardmembers spending and collecting points.

The Principle of an Open Market

In a preferred embodiment, there will be no limitation as to the number of competing merchants or corporate partners who may participate. This is possible because the system provides an incentive to the merchants and CP's for open participation, namely access to important data mining information. Furthermore, the goal of the system itself is the unlimited useability of the reward points, without restriction to a selected merchant group. Only by attracting large numbers of cardmembers with this incentive can the full impact of the data mining be felt. Thus, the entity should not seek just one telecom provider, but all telecom providers as corporate partners; not just one hotel or restaurant chain but all qualified hotel and restaurant chains; and preferably no exclusive memberships for all of the merchant categories.

The hardware of the inventive system includes a server maintained by the entity and connected to the Internet. The rewards program website may reside on the server and offers services to all components of the rewards program. Members, CPs, the financial institution, and merchants can all access the website with an Internet connection.

The card reading devices in the merchant establishments can link up to the server via a modem over an ordinary phone line.

A database containing all the information of the rewards program such as data-mining results, special offers, account information, and member information is also maintained by the entity on its server. The information may be accessed via the Internet with the appropriate security clearances.

The data-mining software is operable to record and track all transactions made by the members and the changes to their reward accounts.

1. A system for administering a purchase-based reward system, comprising:
an administering entity,
memberships issued by the entity to members,
a plurality of merchants participating in the system, and
a monetary trustee account,
wherein when a member makes a purchase through a participating merchant, a monetary value based on the purchase is debited from said merchant and credited to the trustee account,
the member making said purchase is credited with reward points based on the purchase, said reward points being redeemable based on a corresponding value drawn from the trustee account.

2. The system of claim 1, wherein participating merchants are debited an amount based on a pre-determined percentage of the purchase amount.

3. The system of claim 1, wherein reward points are redeemable at associated merchants which accept said reward points toward a purchase based on their corresponding value, and wherein said associated merchants are credited with the amount of said corresponding value from the trustee account.

4. The system of claim 1, wherein reward points are redeemable directly to the member from the trustee account for their corresponding value, to be credited to the member without a further purchase.

5. The system of claim 4, wherein said direct redemption is possible only after the trustee account has accumulated total holdings exceeding a pre-determined minimum

6. The system of claim 1, wherein a pre-determined percentage of the total holdings of the trustee account is credited to the entity as property of the entity.

7. The system of claim 1, wherein the participating merchant is debited a pre-determined amount, in favor of the trustee account, as a transaction fee, in connection with each purchase.

8. The system of claim 1, wherein a pre-determined percentage of the total holdings of the trustee account is set aside for the benefit of the members as a whole.

9. The system of claim 1, wherein memberships are issued by the administering entity in conjunction with a partner entity.

10. The system of claim 9, wherein a pre-determined percentage of the total holdings of the trustee account is set aside for crediting to the partner entities to be used by the partner entities in connection with their activities in furtherance of their participation in the system.

11. The system of claim 1, wherein each member is given a personal identifying means.

12. The system of claim 11, wherein said identifying means is present on an electronically readable card.

13. The system of claim 11, wherein each participating merchant is electronically linked to the system, and the member must present its personal identifying means in connection with the purchase, such that one or more of the following is electronically communicated to the system: the identity of the member, information regarding the particular item purchased, value of the purchase, and an identification of the merchant.

14. The system of claim 13, wherein the member's personal account is automatically credited with reward points upon a purchase.

15. The system of claim 13, wherein a merchant fee is automatically sent from the merchant's bank account to the trustee account.

16. The system of claim 1, wherein each associated merchant is electronically linked to the system, and the member must present its personal identifying means in connection with a reward point redemption at such merchant, such that one or more of the following is electronically communicated between the associated merchant and the system: the identify of the member, the identity of the merchant, the total corresponding value of the reward points in the member's account, the cash equivalent amount of the desired redemption.

17. The system of claim 16, wherein reward points from the member's personal account are automatically debited upon completion of the redemption.

18. The system of claim 16, wherein the account of the associated merchant is automatically credited from the trustee account for the corresponding value of the redemption.
